(19) United States
(12) Patent Application Publication
(10) Pub. No.: US 2006/0192433 A1
(43) Pub. Date: Aug. 31, 2006

(54) Uninterruptible power supply and method for supplying uninterruptible power to a load

(76) Inventors: William A. Fuglevand, Spokane, WA (US); Arthur Rocco, Newman Lake, WA (US)

Correspondence Address: WELLS ST. JOHN P.S., 601 W. FIRST AVENUE, SUITE 1300, SPOKANE, WA, 99201, US

(21) Appl. No.: 11/068,534

(22) Filed: Feb. 28, 2005

(51) Int. Cl. H02J 9/00

(52) U.S. Cl. 307/64

(57) ABSTRACT

An uninterruptible power supply and method for supplying uninterruptible power to a load is described and which includes a source of substantially continuous electrical power for energizing a load which has an electrical power demand; an ultracapacitor which stores electrical energy and which meets the electrical power demand of the load upon an interruption of the substantially continuous electrical power source; and a fuel cell for supplying electrical power to the load following the at least partial discharge of the ultracapacitor.

### TECHNICAL FIELD

The present invention relates to an uninterruptible power supply, and method for supplying uninterruptible power, and more specifically to an arrangement wherein ultracapacitors which have previously stored electrical energy to meet the electrical power demand of a load are discharged, over a period of time which permits a fuel cell to substantially reach full power output, and then subsequently supply electrical power to the load, following the at least partial discharge of at least some of the ultracapacitors.

### BACKGROUND OF THE INVENTION

In assorted commercial and industrial applications, uninterruptible power supplies are necessary in order to maintain crucial systems in an operational state notwithstanding the loss of a primary electrical power source. For example, navigation sites; communication sites; mission critical computer systems; and every railroad crossing signal in the United States must be fully operational 24 hours a day in order to prevent injuries, accidents or interruptions in industrial and commercial processes or business operations.

Heretofore, users desiring to have uninterruptible power supplies for critical or mission essential operations have typically utilized battery banks and/or stand-by generator sets which provide electrical power upon the interruption of the primary AC power source. Most commercially available uninterruptible power supplies for significant electrical systems, typically include some sort of an energy storage device, such as a battery, or banks of batteries, and which are discharged over a period of time while the backup power source, typically a diesel powered generator or similar assembly, is started and then brought online to supply power during the loss of the primary AC power source. In U.S. Pat. No. 6,806,678 to Holmes, a battery charger was disclosed and which included a plurality of fuel cell modules which provided a charging current to backup batteries following the elimination of a primary charging current provided by an AC power source.

While batteries are widely used with fuel cells and operate as an “energy bridge” so to speak, when the electrical power demand of the load exceeds the electrical output of the fuel cell, the perceived value that fuel cells bring to many commercial customers is that they replace large numbers of conventional storage batteries for backup power. In this regard, many customers perceive that conventional batteries are expensive, difficult to maintain and are generally unreliable when exposed to weather extremes. Still further, most batteries are environmentally unfriendly. So, while fuel cells of the design shown in U.S. Pat. No. 6,806,678 and variations thereof eliminate many of the problems associated with these batteries, there is still an overall perception that batteries, although far fewer, are still required to be used in combination with a fuel cell. In addition to the above mentioned perceived shortcomings, there are other problems associated with using batteries in uninterruptible power supplies. Those skilled in the art will recognize that batteries that are cycled through deep electrical discharges, as may be occasioned from time-to-time when the uninterruptible power supplies are employed often experience shortened operational lifetimes. Yet further, other problems associated with batteries include the failure of a charging assembly, which can occasionally malfunction. This may result in the current capacity of the battery bank becoming degraded. In various industry segments, including extremely critical applications this is a completely intolerable situation.

An uninterruptible power supply which addresses these and other perceived shortcomings in the prior art practices is the subject matter of the present application.

### SUMMARY OF THE INVENTION

A first aspect of the present invention relates to an uninterruptible power supply which includes a source of substantially continuous electrical power for energizing a load which has an electrical power demand; an ultracapacitor which stores electrical energy and which meets the electrical power demand of the load upon an interruption of the substantially continuous electrical power source; and a fuel cell for supplying electrical power to the load following the at least partial discharge of the ultracapacitor.

Another aspect of the present invention relates to an uninterruptible power supply which includes a load which has an electrical power demand; an electrical load bus which is electrically coupled to the load; a source of AC power which is electrically coupled to the electrical load bus, and which energizes the load; a plurality of ultracapacitors which are electrically coupled with the electrical load bus, and which further, when electrically charged, and then subsequently at least partially discharged, provides electrical energy to substantially meet the electrical power demand of the load when the source of AC power is substantially interrupted; a charging assembly which is electrically coupled with the source of AC power, and with the plurality of ultracapacitors, and which provides a DC charging current which electrically charges the plurality of ultracapacitors; and a fuel cell which is electrically coupled with the electrical load bus and which, when rendered substantially fully operational, following the interruption of AC power, supplies electrical power to meet the total electrical power demand of the load following the at least partial discharge of the plurality of ultracapacitors.

Still further, another aspect of the present invention relates to an uninterruptible power supply which includes an electrical load bus; a load electrically coupled to the electrical load bus, and which has an electrical power demand; an AC power source which is electrically coupled with the electrical load bus; a plurality of ultracapacitors which are electrically coupled together, and which are further electrically coupled to the electrical load bus, and wherein the respective ultracapacitors are operable to store electrical energy and, when at least partially electrically discharged, following the interruption of the AC power source, to release the electrical energy which has been stored for delivery to the load by way of the electrical load bus; a charging assembly which is electrically coupled with the source of AC power, and which produces an electrical charging current which is delivered to the respective plurality of ultracapacitors, and which electrically charges the respective ultracapacitors; an electrical power converter electrically coupling the plurality of ultracapacitors to the electrical load bus, and wherein the electrical power converter supplies a substantially continuous electrical power supply to meet the electrical power demand of the load as the plurality of ultracapacitors are at least partially discharged; and a selectively actuatable fuel cell which is electrically coupled to the electrical load bus, and with the charging assembly, and wherein the fuel cell is normally inoperable while the source of AC power is being supplied to the load, and which further is actuated, following interruption of the AC power source, and after a time delay, is operable to produce electrical power which is delivered to the electrical load bus, following the at least partial electrical discharge of the plurality of ultracapacitors, to substantially meet the electrical power demand of the load, and the substantially continuous delivery of the electrical charging current to the plurality of ultracapacitors.

In addition to the foregoing, a method for supplying uninterruptible power to a load includes the steps of providing a source of substantially continuous electrical power which energizes a load; providing an ultracapacitor which stores electrical energy, and which is supplied to the load upon the interruption of the substantially continuous power source; providing a fuel cell, and electrically coupling the fuel cell to the load, and wherein the fuel cell is substantially inoperable when the substantially continuous source of electrical power is provided to the load; releasing at least in part, a portion of the electrical energy stored in the ultracapacitor to energize the load upon the interruption of the substantially continuous source of electrical power, and over a time period which permits the fuel cell to become substantially fully operable, and generate electrical power which can energize the load; and after the step of releasing, at least in part, the electrical energy stored by the ultracapacitor to energize the load, supplying the electrical power generated by the fuel cell when the fuel cell is rendered operable to energize the load.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly simplified, schematic diagram of the uninterruptible power supply and method for supplying uninterruptible power to a load of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

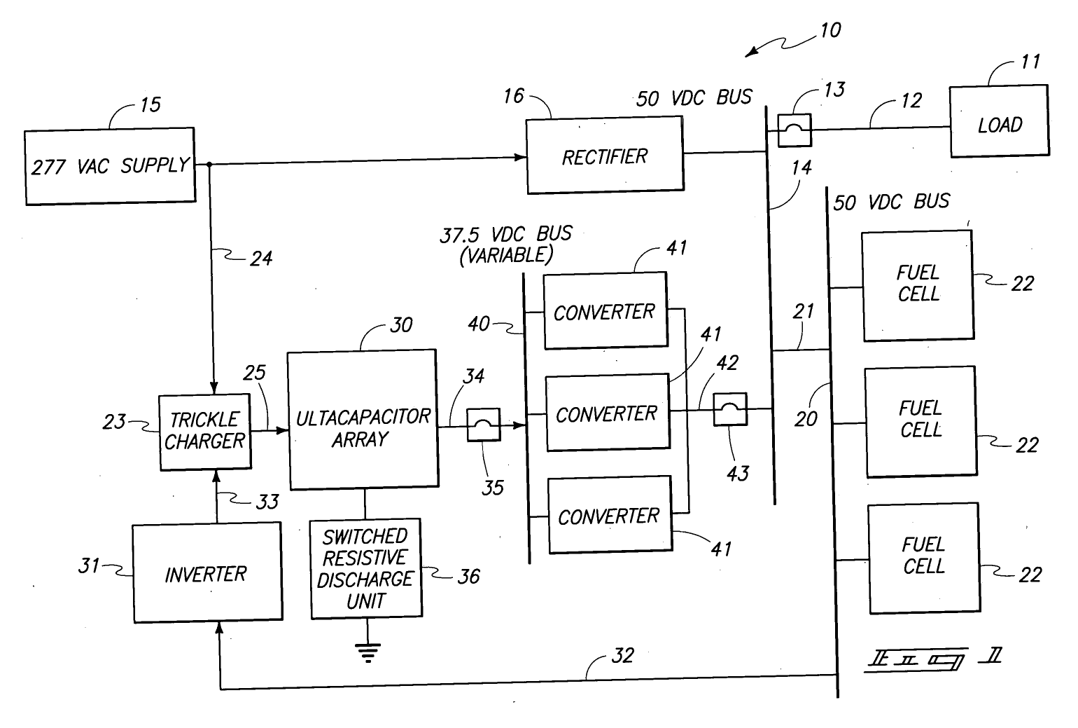

An uninterruptible power supply, and method for supplying uninterruptible power to a load is best understood by a study of the schematic view of FIG. 1. As seen therein, the uninterruptible power supply is generally indicated by the numeral 10 in that view. The uninterruptible power supply is operable to supply electrical power for energizing a load 11 which has an electrical power demand. For purposes of this application, and to solely explain the principals of the present invention, it will be understood that the load requires a substantially constant 50 volts DC. In this regard, an electrical conduit 12 is electrically coupled to the load 11. Still further, a 75 amp circuit breaker 13 is positioned therealong the electrical conduit, and the electrical conduit is further electrically coupled to a first electrical load bus, here illustrated as a 50 volt DC bus, and which is generally indicated by the numeral 14. As illustrated in FIG. 1, a source of AC power, here illustrated as a 277 volt AC power supply 15 is electrically coupled with the first electrical load bus 14. The source of AC power 15 is first delivered to a rectifier 16 which in turn is electrically coupled to the first load bus. A suitable rectifier may be purchased from Eltek under the trade name Flatpack. The rectifier is operable to act upon the source of AC power in order to deliver a reduced amount of voltage as illustrated, that is, approximately 48 to about 50 volts DC to the first load bus 14 for use in meeting the power demand of the load 11.

As illustrated in FIG. 1, the uninterruptible power supply 10 of the present invention includes a second load bus which is generally indicated by the numeral 20. This particular load bus which has a nominal voltage of about 50 volt DC is electrically coupled by means of an electrical conduit 21, to the first load bus 14 as illustrated. Still further, a plurality of fuel cells which are generally indicated by the numeral 22 are electrically coupled to the second load bus 20. In the arrangement as shown, the fuel cells are selectively actuatable fuel cells of the prior art. These fuel cells may include stack and non-stack arrangements, as well fuel cells having a plurality of modules which are each operable, at least in part, to supply the electrical power to meet the demand of the load 11. In the arrangement as seen in FIG. 1, the respective fuel cells 22 are normally inoperable while the source of AC power 15 is being supplied to the load 11. By the term “normally inoperable,” it should be understood that the respective fuel cell will not be providing an electrical power output which would support the electrical demand of the load. The respective fuel cells could be providing, for example, some electrical power (typically less than about 5% of the required power of the load) or no power at all, depending upon the arrangement. In each of these non-limiting examples above, the fuel cells would be considered ‘non-operable.’ The respective fuel cells are only actuated following the interruption of the AC power source, and after a time delay during which the fuel cells increase their respective output power until they are rendered substantially fully operable to produce the electrical power required by the load 11, and which is then delivered to the first electrical load bus 14 by way of the second electrical load bus 20. A fuel cell or cells are substantially fully operable when the fuel cell or cells are producing greater than about 80% of their fully rated power output. This increase in the delivery of electrical power by the respective fuel cells following the substantial interruption of AC power is concurrent with the at least partial electrical discharge of a plurality of ultracapacitors, which will be discussed in greater detail hereinafter. A substantial interruption of the AC power to the load would be a loss of greater than about 5% of the electrical power needed to service the load.

In the arrangement as seen in FIG. 1, a charging assembly, here indicated as a 2.5 volt DC trickle charger 23, is electrically coupled with the source of AC power 15 by means of an electrical conduit 24. The charging assembly 23 provides a charging current output 25 which electrically charges a plurality of ultracapacitors here indicated by the numeral 30. Suitable ultracapacitors may be secured from Maxwell under the trade name PC2500. These capacitors individually have capacitance ratings as indicated by the manufacturer as much as 2700 Farads. Any number of ultracapacitors may be chosen and which may be placed in arrays of capacitors configured in series, parallel, or both. In the arrangement as shown, as many as 90 ultracapacitors may be configured as six serial groups of 15 ultracapacitors which are electrically coupled, in parallel.

As seen in FIG. 1, an inverter 31 is provided. In the arrangement as shown, any excess power output of the fuel cell(s) 32, as provided by the second electrical bus 20 after the electrical power requirements of the load 11 are met, is supplied to the inverter. The inverter, upon receiving the electrical power from the respective fuel cells 22 provides a power output to the charging assembly 23. This electrical power is provided when the source of AC power 15 is interrupted, as described above. In the arrangement as shown, the charging assembly is operable to convert the AC voltage supply 15 to a 2.5 volt DC current, and which is utilized to charge an array of ultracapacitors 30 which will be described below. The invention 31 may include a time delay control which is electrically coupled with a relay of the source of AC power 15.

As discussed above, the charging assembly 23 of the present invention and which is coupled to both the AC power supply 15 as well as the second load bus 20 includes a toroidal transformer, not shown, with 15 isolated secondary windings which are typically rated at about 4.2 Vrms. These in turn are connected to a diode bridge rectifier and voltage regulator to generate a substantially fixed 2.5 volt DC power output 25 and which in turn are connected to groups of parallel ultracapacitors which are then typically electrically coupled in series together, and which are generally indicated by the numeral 30. In the arrangement as shown, a relatively small charging current, is provided. This provides several advantages. For example, smaller regulators, transformers, wires and connectors are needed. If desired, a larger charging circuit can be selected that can handle greater current to allow for more rapid charging of the ultracapacitor 30 or banks of ultracapacitors that may be utilized in the present invention 10. In the arrangement as shown, once the respective ultracapacitors are fully charged, that is, the voltage typically reaches 2.5 volts DC nominal voltage, the respective ultracapacitor(s) draw no further electrical current from the charging assembly and the ultracapacitor(s) as will be described hereinafter are ready to supply electrical current to meet the energy requirements of a load 11 upon interruption of the AC power source 15. As noted above, the respective ultracapacitor(s) 30 are typically electrically coupled in parallel to make groups of ultracapacitors that operate at a nominal 2.5 Volts DC. These groups of ultracapacitor(s) may be connected in series to supply a nominal 37.5 volt DC output 34 which is protected by a 150 amp DC circuit breaker 35. As seen in the drawing, a switched resistive discharge unit 36 is electrically coupled to the ultracapacitor array 30, and is thereafter electrically coupled to ground.

In the arrangement as shown, a third electrical bus 40 is provided, and the electrical output 34 as provided by the plurality of ultracapacitors 30, is supplied to the third electrical bus. As seen in the arrangement of FIG. 1, one or more DC to DC converters, here indicated by the numeral 41, are electrically coupled to the third electrical bus 40. The respective electrical converters increase the 37.5 volt variable DC electrical output provided by the plurality of ultracapacitors to produce a 50+volt DC regulated output which is required for the first electrical bus 14. In the arrangement as shown, the plurality of ultracapacitors can supply the electrical needs of the load 11 through the first electrical bus 14 as will be described below. In the arrangement as seen, the respective DC to DC converters 41 are electrically coupled to the first electrical bus 14 by way of an electrical conduit 42. A 75 amp DC circuit breaker 43 is provided therealong the electrical conduit 42. In the arrangement as seen in FIG. 1, the DC to DC converters 41, which may comprise one to several, are designed to accommodate an input voltage ranging from about 16 volts DC to over 37.5 volt DC, and still provide a substantially constant 50+voltage DC output as provided to the first electrical bus 14. This wide input range for the respective DC to DC converters and which is provided by the plurality of ultracapacitors 30 is necessary to convert the electrical output voltage of the respective ultracapacitors, as they decrease in stored electrical energy, and while the plurality of ultracapacitors are being at least partially discharged. In an alternative configuration, not shown, some of the groups of the ultracapacitors may be selectively discharged while other groups remain fully charged. In the arrangement as seen in FIG. 1, the load 11 is normally served from a first electrical bus 14, here illustrated as a 48 volt DC bus. A rectifier 16 which is supplied with the source of AC power 15, from a utility grid, is electrically coupled to the first electrical bus 14. In the arrangement as shown, the uninterruptible power supply 10 of the present invention is adapted to continuously provide electrical power to the load 11, without any substantial interruption, sag or surge in voltage, if the source of AC power 15 or the rectifier 16 fails. In the arrangement as seen in FIG. 1, the uninterruptible power supply 10 includes at least one fuel cell 22, or a plurality of fuel cells 22 that can supply electrical power to the first electrical load bus 14 substantially continuously as long as fuel, not shown, is supplied to the respective fuel cells. It should be understood that since no fuel cell, or any commercially available generator, for that matter, can start and deliver electrical power instantaneously, the plurality of charged ultracapacitors 30 are provided, and which are at least partially discharged to release electrical power to meet the electrical power demands of the load 11 during the time period when the respective fuel cells 22 are started, and then subsequently reach their full electrical power output.

Therefore in its broadest aspect, the uninterruptible power supply 10 of the present invention includes a source of substantially continuous electrical power 15 for energizing a load 11, and which has an electrical power demand; a fuel cell 22 for supplying electrical power to the load 11 following an interruption of the substantially continuous electrical power source; and an ultracapacitor 30 which stores electrical energy and which meets the electrical power demand of the load 11 as the fuel cell 22 which is substantially inoperable, begins initial operation, and increases its electrical power output until its power output can substantially fully meet the demands of the load 11. As earlier discussed, the fuel cell may comprise, at least in part, a plurality of fuel cell modules as seen in U.S. Pat. Nos. 6,030,718 and 6,468,682, the teachings of which are incorporated by reference herein, and wherein at least some of the individual fuel cell modules may be removed from the fuel cell 22 by hand while the remaining fuel cell modules remain operational. In the arrangement as seen in FIG. 1, the fuel cell may comprise a plurality of fuel cells 22 which, when collectively energized, produce an electrical power output which substantially meets the electrical power demand of the load 11. As seen in FIG. 1, a charging assembly 23 is provided for electrically charging the ultracapacitor 30, referenced above. The charging assembly is electrically coupled with the source of substantially continuous electrical power 15, and with the fuel cell 22. The charging assembly 23 provides a charging voltage of about 2.0 to about 3.0 volts DC to the ultracapacitor(s) 30.

As earlier discussed, the ultracapacitor 30 may comprise a plurality of ultracapacitors 30, and the charging assembly 23 may further include a transformer (not shown) for electrically charging the plurality of ultracapacitors which are in the electrical arrangement, as earlier disclosed. The transformer, in this arrangement, is electrically coupled with the source of substantially continuous electrical power 15, and further includes a plurality of secondary windings (not shown) which correspond in number with the plurality of ultracapacitors 30 which are formed into groups, and which are individually electrically coupled with the respective ultracapacitors. In the arrangement as shown, the uninterruptible power supply 10 may further include one or more electrical power converters 41 which are electrically coupled to the ultracapacitor 30, and the load 11, and which receive the electrical power discharged from the ultracapacitor 30. The electrical power converter is operable to subsequently supply a substantially constant electrical voltage which meets the electrical power demand of the load 11.

In addition to the foregoing, the uninterruptible power supply 10 of the present invention includes an inverter 31 which is electrically coupled to at least one of the fuel cells 22, and which supplies electrical power generated by the fuel cell(s) to the charging assembly 23 upon the interruption of the substantially continuous electrical power source 15, and provided that the fuel cells 22 have an electrical power output which is in excess of the electrical power demands of the load 11. In the arrangement as shown, the fuel cell, or plurality of fuel cells 22 are substantially inoperable while the source of the substantially continuous electrical power 15 is being supplied to the load 11. Typically, the respective ultracapacitors 30 are normally fully charged while the source of the substantially continuous electrical power 15 is being supplied to the load 11. In the arrangement as seen in FIG. 1, the fuel cell or plurality of fuel cells 22 following the interruption of the substantially continuous electrical power source, requires a time period before which the fuel cell or plurality of fuel cells are rendered substantially fully operable to supply the electrical power which meets the electrical power demand of the load 11. In the arrangement as seen, the ultracapacitor(s) 30 are discharged, at least in part, and which supplies the electrical power to meet the electrical power demand of the load 11 during the time period following interruption of the AC power source 15, and the fuel cell being rendered substantially fully operable to service the load. In the arrangement as shown, the plurality of ultracapacitors 30 are first partially discharged over a first time period wherein the fuel cell is substantially inoperable and immediately following the interruption of the source of AC power 15. This discharged power is supplied to the electrical load bus 14. A second time period then elapses during which the fuel cell is activated, but is not rendered substantially fully operable to produce electrical power to meet the power demand of the load 11. During this second time period, the output of the respective fuel cells 22 increases to reach the substantially full electrical power output required to serve the needs of the load 11. The first time period may be from about 10 minutes to about 60 seconds, and the second time period may be about 30 seconds to about 15 minutes. As seen in FIG. 1 the fuel cell 22 as described, above, may comprise a plurality of fuel cells 22, and the uninterruptible power supply 10 of the present invention further comprises a second electrical load bus 20, which is electrically coupled to the first electrical load bus 14, and wherein the second electrical load bus 20 is electrically coupled to the plurality of fuel cells 22.

As earlier discussed, the uninterruptible power supply 10 of the present invention, and as described above, may include one or more electrical power converters 41 which are electrically coupled to the plurality of ultracapacitors 30, and the load 11. In the arrangement as seen in FIG. 1, the electrical power converters individually or severally receive the electrical power discharged from the plurality of ultracapacitors 30, and which further subsequently supplies a substantially constant electrical power supply which meets the electrical power demand of the load 11. The electrical power converter(s) 41 are individually electrically coupled with the first electrical load bus 14. In the arrangement as seen in FIG. 1, and where a plurality of electrical power converters are employed, a third electrical load bus 40 may be provided and which is electrically coupled with the individual power converters 41, and the plurality of ultracapacitors 30. The uninterruptible power supply 10 further includes a rectifier 16 which is coupled with the source of AC power 15. The rectifier has an electrical output which is delivered, at least in part, to the first electrical load bus 14. In addition, and as seen in FIG. 1, an inverter 31 is provided and which is electrically coupled to the fuel cell 22, and the charging assembly 23. In the arrangement as shown, the inverter supplies electrical power generated by the fuel cell to the charging assembly upon the interruption of the AC power source 15 provided that there is excess electrical power available from the fuel cells 22 after the power requirements of the load 11 are met.

### OPERATION

The operation of the described embodiment of the present invention is believed to be readily apparent and is briefly summarized at this point.

Referring to FIG. 1 an uninterruptible power supply 10 of the present invention includes an electrical load bus 14; a load 11 which is electrically coupled to the electrical load bus, and which has an electrical power demand; and a source of AC power 15 which is electrically coupled with the electrical load bus. In the form of the invention as seen in the drawing, a plurality of ultracapacitors 30 are provided, and which are electrically coupled together and which are further electrically coupled to the electrical load bus 14. In the arrangement as seen, the respective ultracapacitors are operable to store electrical energy and, when at least partially electrically discharged, following the interruption of the AC power source, to release the electrical energy which has been stored for delivery to the load 11, by way of the electrical load bus 14. As further seen in the drawing, a charging assembly 23 is provided and which is operable to selectively electrically charge the ultracapacitor(s) 30. As further understood by the drawing, an electrical power converter 41 is provided, and which electrically couples the plurality of ultracapacitors 30 to the electrical load bus 14. The electrical power converter(s) supplies a substantially continuous electrical power supply to meet the electrical power demand of the load 11 when the plurality of ultracapacitors are discharged. As understood by the drawing, a selectively actuatable fuel cell 22 is provided and which is electrically coupled to the electrical load bus 14, and the charging assembly 23. The fuel cell 22, which may include a plurality of fuel cells, is normally inoperable while the source of AC power 15 is being supplied to the load 11. As earlier discussed, the fuel cell 22 which is actuated, following interruption of the AC power source, and after a time delay, is fully operable to produce electrical power which is delivered to the electrical load bus, following the at least partial electrical discharge of the plurality of ultracapacitors, to substantially meet the electrical power demand of the load 11, and if conditions warrant, the substantially continuous delivery of the electrical charging current to the plurality of ultracapacitors 30. In the arrangement as seen in FIG. 1, it should be understood that the selectively actuatable fuel cell may comprise, at least in part, a plurality of fuel cell modules, and wherein at least some of the fuel cell modules may be removed from the fuel cell, by hand, while the remaining fuel cell modules remain operational. Still further, the fuel cell 22 may comprise a plurality of fuel cells, and wherein the plurality of fuel cells are configured in a stack and/or non-stack arrangement. As seen in the drawing, a rectifier 16 is provided and which is electrically coupled with the AC power source 15. The rectifier is further electrically couple with the electrical load bus 14. The rectifier converts the AC power into a DC power output which is delivered to the electrical load bus 14.

The present invention as shown in FIG. 1 provides a method for supplying uninterruptible power to a load 11, and which includes the steps of providing a source of substantially continuous electrical power 15 which energizes a load 11; and providing an ultracapacitor 30 which stores electrical power, and which is subsequently supplied to the load 11 upon the interruption of the substantially continuous power source 15. The methodology as described includes further steps of providing a fuel cell 22, and electrically coupling the fuel cell to the load 11. In this step, the fuel cell is substantially inoperable when the substantially continuous source of electrical power 15 is provided to the load. Furthermore, in this step, the ultracapacitors 30 are typically substantially fully charged. In addition to the foregoing, the methodology of the present invention includes a step of releasing, at least in part, a portion of the electrical energy stored in the ultracapacitor 30 to energize the load 11 upon the interruption of the substantially continuous source of electrical power 15, and over a time period which permits the fuel cell 22 to become substantially fully operable and generate electrical power which can substantially fully serve the electrical demand of the load 11. In addition to the foregoing, the methodology includes an additional step following the step of releasing the electrical energy stored by the ultracapacitor 30 to energize the load 11, supplying the electrical power generated by the fuel cell 22 when the fuel cell is rendered operable to energize the load 11. In the methodology as described, the source of substantially continuous electrical power comprises a source of AC power 15, and further the method further comprises an additional step of providing a rectifier 16, which receives the source of AC power, and which converts the source of AC power into a first DC power output which energizes the load 11. The methodology as described, includes a further step of converting the electrical energy 41 which is released from the ultracapacitor 30 into a second DC electrical power output which energizes the load following the interruption of the AC power source 15. As seen in FIG. 1, the methodology as described further includes an additional step of providing a charging assembly 23, and electrically coupling the charging assembly 23 with the source of AC power 15, and wherein the charging assembly 23 produces a charging current 25 which is supplied to the ultracapacitor 30. As seen in FIG. 1, the methodology as described includes yet still another additional step of supplying a portion of the electrical power generated by the fuel cell 22 to the charging assembly following the interruption of the AC power source 15 once the respective fuel cells 22 reach, and are producing, electricity at their rated full operational output levels or amounts. In this regard, an inverter 31 is provided and which is electrically coupled to the individual fuel cells 22, and which receives excess electrical power generated by the fuel cells upon interruption of the AC power source 15. As described earlier, the time period over which the ultracapacitor 30 releases the stored electrical energy is typically greater than about 10 minutes, but it could be less than this, depending upon the conditions.

Therefore it will be seen that the present invention provides many advantages over the prior art practices and ensures that an uninterruptible power supply may be in a fully charged and ready state in order to service a load 11 under all operational conditions and notwithstanding interruption of a primary source of AC power which is normally provided to service the load.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. An uninterruptible power supply, comprising:
a source of substantially continuous electrical power for energizing a load which has an electrical power demand;
an ultracapacitor which stores electrical energy and which meets the electrical power demand of the load upon an interruption of the substantially continuous electrical power source; and
a fuel cell for supplying electrical power to the load following the at least partial discharge of the ultracapacitor.

2. An uninterruptible power supply as claimed in claim 1, and wherein the fuel cell further comprises, at least in part, a plurality of fuel cell modules, and wherein at least some of the individual fuel cell modules may be removed from the fuel cell, by hand, while the remaining fuel cell modules remain operational.

3. An uninterruptible power supply as claimed in claim 1, and wherein the fuel cell comprises a plurality of fuel cells which, when collectively energized, produce an electrical power output which substantially meets the electrical power demand of the load.

4. An uninterruptible power supply as claimed in claim 1, and further comprising:
a charging assembly for electrically charging the ultracapacitor, and which is electrically coupled with the source of substantially continuous electrical power, and with the fuel cell, and wherein the charging assembly provides a charging voltage of about 2.0 to about 3.0 volts DC to the ultracapacitor.

5. An uninterruptible power supply as claimed in claim 4, and wherein the ultracapacitor comprises a plurality of ultracapacitors, and wherein the charging assembly further comprises:
a transformer for electrically charging the plurality of ultracapacitors, and which further is electrically coupled with the source of substantially continuous electrical power, and with the fuel cell, and wherein the transformer further includes a plurality of isolated secondary windings corresponding in number with the plurality of ultracapacitors, and which are individually electrically coupled with the respective ultracapacitors.

6. An uninterruptible power supply as claimed in claim 5, and wherein the plurality of ultracapacitors are each electrically coupled in series, one relative to the other.

7. An uninterruptible power supply as claimed in claim 5, and wherein at least two of the plurality of ultracapacitors are electrically coupled together in parallel to form a group.

8. An uninterruptible power supply as claimed in claim 7, and wherein at least two of the parallel groups of ultracapacitors are electrically coupled together in series.

9. An uninterruptible power supply as claimed in claim 1, and further comprising:
an electrical power converter which is electrically coupled to the ultracapacitor and the load, and which receives the electrical power discharged from the ultracapacitor, and which subsequently supplies a substantially continuous electrical power supply which meets the electrical power demand of the load.

10. An uninterruptible power supply as claimed in claim 1, and wherein the fuel cell includes at least some air cooled fuel cell modules, and wherein the individual air cooled fuel cell modules, during operation, produce heat as a byproduct, and wherein a source of air is supplied to the respective air cooled fuel cell modules and which is operable to remove a preponderance of the heat which is produced as a byproduct of each of the air cooled fuel cell modules operation.

11. An uninterruptible power supply as claimed in claim 10, and wherein the individual air cooled fuel cell modules are configured in a non-stack arrangement.

12. An uninterruptible power supply as claimed in claim 10, and wherein at least some of the individual fuel cell modules are not air cooled, and are further configured in a stack arrangement.

13. An uninterruptible power supply as claimed in claim 10, and wherein the fuel cell comprises a plurality of fuel cells which are configured in either a stack, and/or a non-stack arrangement.

14. An uninterruptible power supply as claimed in claim 4, and further comprising:
an inverter which is electrically coupled to the fuel cell, and with the charging assembly, and which supplies electrical power generated by the fuel cell to the charging assembly upon the interruption of the substantially continuous electrical power source.

15. An uninterruptible power supply as claimed in claim 1, and wherein the fuel cell is substantially inoperable while the source of the substantially continuous electrical power is being supplied to the load.

16. An uninterruptible power supply as claimed in claim 15, and wherein the fuel cell following the interruption of the substantially continuous electrical power source, requires a time period before the fuel cell is rendered substantially fully operable to supply the electrical power which meets the electrical power demand of the load, and wherein the ultracapacitor is discharged, at least in part, and supplies electrical power to meet the electrical power demand of the load during the time period following interruption of the AC power source, and the fuel cell being rendered substantially fully operable.

17. An uninterruptible power supply, comprising:
a load which has an electrical power demand;
an electrical load bus which is electrically coupled to the load;
a source of AC power which is electrically coupled to the electrical load bus and which energizes the load;
a plurality of ultracapacitors which are electrically coupled with the electrical load bus and which further, when electrically charged, and then subsequently at least partially discharged, provides electrical energy to substantially meet the electrical power demand of the load when the source of AC power is substantially interrupted;
a charging assembly which is electrically coupled with the source of AC power, and with the plurality of ultracapacitors, and which provides a DC charging current which electrically charges the plurality of ultracapacitors; and
a fuel cell which is electrically coupled with the electrical load bus and which, when rendered substantially fully operational, following the interruption of AC power, supplies electrical power to meet the electrical power demand of the load following the at least partial discharge of the plurality of ultracapacitors.

18. An uninterruptible power supply as claimed in claim 17, and wherein the fuel cell has a plurality of fuel cell modules which are each operable to supply, at least in part, the electrical power to meet the power demand of the load following the at least partial discharge of the plurality of ultracapacitors, and wherein at least some of the fuel cell modules may be readily removed, and/or replaced by hand while the remaining fuel cell modules continue in operation.

19. An uninterruptible power supply as claimed in claim 17, and wherein the fuel cell includes a plurality of fuel cells which are each operable to supply, at least in part, the electrical power to meet the power demand of the load following the at least partial discharge of the plurality of ultracapacitors, and wherein the plurality of fuel cells are configured in either a stack and/or non-stack arrangement.

20. An uninterruptible power supply as claimed in claim 17, and wherein the plurality of ultracapacitors are partially discharged over a first time period, following an interruption of the source of AC power, and when the fuel cell is substantially inoperable, and a second time period during which the fuel cell is activated, but is not rendered substantially fully operable to produce substantially all the electrical power to meet the power demand of the load.

21. An uninterruptible power supply as claimed in claim 20, and wherein the first time period is about 10 seconds to about 60 seconds, and wherein the second time period is about 30 seconds to about 15 minutes.

22. An uninterruptible power supply as claimed in claim 17, and wherein the fuel cell comprises a plurality of fuel cells, and wherein the uninterruptible power supply further comprises a second electrical, load bus, and wherein the second electrical load bus is coupled to the first electrical load bus, and wherein the second electrical load bus is electrically coupled to the plurality of fuel cells.

23. An uninterruptible power supply as claimed in claim 17, and further comprising:
an electrical power converter which is electrically coupled to the plurality of ultracapacitors and the load, and wherein the electrical power converter receives the electrical energy which is at least partially discharged from the plurality of ultracapacitors, and which further subsequently supplies a substantially continuous electrical power supply which meets the electrical power demand of the load, and wherein the electrical power converter is electrically coupled with the electrical load bus.

24. An uninterruptible power supply as claimed in claim 23, and wherein the fuel cell comprises a plurality of fuel cells, and wherein the electrical power converter comprises a plurality of electrical power converters, and wherein the uninterruptible power supply further comprises:
a second electrical load bus which is electrically coupled with the plurality of fuel cells, and the first electrical load bus; and
a third electrical load bus which is electrically coupled with the plurality of electrical power converters, and with the first electrical load bus.

25. An uninterruptible power supply as claimed in claim 17, and further comprising:
a rectifier which is electrically coupled with the source of AC power, and wherein the rectifier has an electrical power output which is delivered to the electrical load bus.

26. An uninterruptible power supply as claimed in claim 25, and wherein the electrical power output of the rectifier is less than about 50 volts DC.

27. An uninterruptible power supply as claimed in claim 17, and wherein the charging assembly provides a charging current of less than about 3 volts DC.

28. An uninterruptible power supply as claimed in claim 17, and further comprising:
an inverter which is electrically coupled to the fuel cell, and the charging assembly, and wherein the inverter supplies electrical power generated by the fuel cell to the charging assembly upon the interruption of the AC power source.

29. An uninterruptible power supply as claimed in claim 17, and wherein the charging assembly comprises a transformer having a plurality of isolated windings.

30. An uninterruptible power supply, comprising:
an electrical load bus;
a load electrically coupled to the electrical load bus, and which has an electrical power demand;
an AC power source which is electrically coupled with the electrical load bus;
a plurality of ultracapacitors which are electrically coupled together and which are further electrically coupled to the electrical load bus, and wherein the respective ultracapacitors are operable to store electrical energy and, when at least partially electrically discharged, following the interruption of the AC power source, to release the electrical energy which has been stored for delivery to the load by way of the electrical load bus;
a charging assembly which is electrically coupled with the source of AC power, and which produces an electrical charging current which is delivered to the respective plurality of ultracapacitors, and which electrically charges the respective ultracapacitors;
an electrical power converter electrically coupling the plurality of ultracapacitors to the electrical load bus, and wherein the electrical power converter supplies a substantially continuous electrical power supply to meet the electrical power demand of the load when the plurality of ultracapacitors are at least partially discharged; and
a selectively actuatable fuel cell which is electrically coupled to the electrical load bus, and with the charging assembly, and wherein the fuel cell is normally inoperable while the source of AC power is being supplied to the load, and which further is actuated, following interruption of the AC power source, and after a time delay, is operable to produce electrical power which is delivered to the electrical load bus, following the at least partial electrical discharge of the plurality of ultracapacitors, to substantially meet the electrical power demand of the load, and the substantially continuous delivery of the electrical charging current to the plurality of ultracapacitors.

31. An uninterruptible power supply as claimed in claim 30, and wherein the selectively actuatable fuel cell further comprises, at least in part, a plurality of fuel cell modules, and wherein at least some of the fuel cell modules may be removed from the fuel cell, by hand, while the remaining fuel cell modules remain operational.

32. An uninterruptible power supply as claimed in claim 31, and wherein the fuel cell comprises a plurality of fuel cells, and wherein the plurality of fuel cells are configured in a stack and/or non-stack arrangement.

33. An uninterruptible power supply as claimed in claim 30, and further comprising:
a rectifier which is electrically coupled with the AC power source, and with the electrical load bus, and wherein the rectifier converts the AC power into a DC power output which is delivered to the electrical load bus.

34. An uninterruptible power supply as claimed in claim 33, and further comprising:
a second electrical load bus which is electrically coupled with the first mentioned electrical load bus, and wherein the fuel cell comprises a plurality of fuel cells which are individually electrically coupled with the second electrical load bus.

35. An uninterruptible power supply as claimed in claim 34, and further comprising:
a third electrical load bus which is electrically coupled to the first mentioned electrical load bus, and wherein the plurality of ultracapacitors are electrically coupled with the third electrical load bus.

36. An uninterruptible power supply as claimed in claim 35, and further comprising:
an inverter which is electrically coupled with the second electrical load bus, and with the charging assembly, the inverter receiving an electrical current which is generated by the fuel cell and delivering at least a portion of the electrical current generated by the fuel cell to the charging assembly.

37. An uninterruptible power supply as claimed in claim 36, and wherein the charging current produced by the charging assembly is provided at a voltage of less than about 3.0 volts D.C.

38. An uninterruptible power supply as claimed in claim 33, and wherein the time delay is measured from the actuation of the substantially inoperable fuel cell, to the delivery of the electrical power from the fuel cell to the load, and following the at least partial electrical discharge of the plurality of ultracapacitors, and wherein the time delay is less than about 30 minutes.

39. A method for supplying uninterruptible power to a load, comprising:
providing a source of substantially continuous electrical power which energizes a load;
providing an ultracapacitor which stores electrical energy, and which is supplied to the load upon the interruption of the substantially continuous power source;
providing a fuel cell, and electrically coupling the fuel cell to the load, and wherein the fuel cell is substantially inoperable when the substantially continuous source of electrical power is provided to the load;
releasing at least in part, a portion of the electrical energy stored in the ultracapacitor to energize the load upon the interruption of the substantially continuous source of electrical power, and over a time period which permits the fuel cell to become substantially fully operable and generate electrical power which can energize the load; and
after the step of releasing, at least in part, the electrical energy stored by the ultracapacitor to energize the load, supplying the electrical power generated by the fuel cell when the fuel cell is rendered operable to energize the load.

40. A method as claimed in claim 39, and wherein the source of substantially continuous electrical power comprises a source of AC power, and wherein the method further comprises:
providing a rectifier which receives the source of AC power, and which converts the source of AC power into a first DC power output which energizes the load.

41. A method as claimed in claim 40, and further comprising:
converting the electrical energy which is released from the ultracapacitor into a second DC electrical power output which energizes the load following the interruption of the AC power source.

42. A method as claimed in claim 41, and further comprising:
providing a charging assembly, and electrically coupling the charging assembly with the source of AC power, and wherein the charging assembly produces a charging current which is supplied to the ultracapacitor.

43. A method as claimed in claim 42, and further comprising:
supplying a portion of the electrical power generated by the fuel cell to the charging assembly upon the interruption of the AC power source.

44. A method as claimed in claim 42, and wherein the time period over which the ultracapacitor releases the stored electrical energy is greater than about 10 minutes.
